(19) United States
(12) Patent Application Publication
(10) Pub. No.: US 2014/0130521 A1
(43) Pub. Date: May 15, 2014

(54) Configurations and Methods for Ambient Air Vaporizers and Cold Utilization

(71) Applicant: FLUOR TECHNOLOGIES CORPORATION, Aliso Viejo, CA (US)

(72) Inventor: John Mak, Santa Ana, CA (US)

(73) Assignee: FLUOR TECHNOLOGIES CORPORATION, Aliso Viejo, CA (US)

(21) Appl. No.: 13/674,722

(22) Filed: Nov. 12, 2012

(51) Int. Cl. F17C 3/00

(52) U.S. Cl. CPC F17C 3/00
USPC 62/45.1

(57) ABSTRACT

An ambient air LNG vaporizer has a housing that encloses the exchanger conduits and provides a stream of refrigerated air to a blower to so convey refrigerated air to one or more remote refrigerated air consumers. The temperature of the refrigerated air is maintained using a control circuit that adjusts an operational parameter of an ambient air intake control device of the housing and/or the blower.

### FIELD OF THE INVENTION

The field of the invention is configurations and methods for regasification of liquefied natural gas (LNG), especially as it relates to ambient air vaporizers.

### BACKGROUND OF THE INVENTION

Traditional methods of LNG vaporization employs submerged combustion vaporizers, which often consume up to 3% of the vaporized product for operation and thus substantially impact profitability. Moreover, NOx and various greenhouse emissions from the combustion processes cause environmental problems. Alternatively, seawater can be used as heat source. However, such methods typically produce cold seawater that can adversely affect sea life and often require further chemicals treatment. The cost of a seawater system is also very high, making the use of seawater impractical, particularly with land-based LNG terminals.

One of the more environmentally acceptable methods of LNG regasification is the use of heat from ambient air. However, heating with ambient air tends to generate relatively large quantities of cold air and in certain atmospheric conditions dense ground fog. In most other applications, the heating duties for ambient air vaporizers are small relatively and fog is thus readily dissipated, but in LNG regasification facilities, the heating duty for a 1,000 MMscfd regasification operation typically requires about 600 MM Btu/hour and the amount of fog generated is often intense, which tends to cause a hazard and visibility problems in the vicinity of the regasification facility.

Liquefaction of LNG is very energy intensive and typically consumes about 10% of the LNG product. At least some of the energy can be recovered by making use of the large refrigeration content of LNG. While there are various known configurations and methods of cold recovery (e.g., in power generation such as Rankine cycle power generation, gas turbine air inlet chilling via heat transfer fluids, etc.), implementation proves difficult. Among other problems, the relatively large distance between the LNG plant and the power plant often requires long heat exchange fluid circuits, rendering cold recovery less than economically attractive. Such large distances (e.g., more than 1 km) are generally required to ensure LNG plant safety in case of power plant upsets or accidents. For example, LNG direct integration with a power plant integration as proposed by Tagawa in EP 2 133 515 A1 that uses the cold air from the LNG ambient air vaporizer to directly feed the gas turbine, was deemed unsafe and risky as the vaporizer and the power plant were substantially co-located.

To overcome such difficulties, a heat transfer medium recycle loop between the LNG vaporizer and a gas turbine air precooler can be implemented as described in U.S. Pat. No. 5,400,588. While a heat transfer medium loop allows for a safe separation between the LNG plant and power plant, the use of a large heat transfer system is often costly and rarely justified (e.g., due to large diameter pressurized pipes and significant circulation rates). In another example, as shown in WO 2010/009371, a regasification facility uses a combination of ambient and non-ambient air as continuous heat sources to regasify LNG. Such approach, however, also requires a heat transfer medium and as such suffers from the same drawbacks.

In yet another known approach as shown in WO 02/097252, LNG is vaporized in a system that uses a working fluid in a work producing cycle while chilling liquids in a direct contact heat transfer system to cool gas turbine air. However, the proposed solution poses a potential hazard as the LNG is vaporized by direct contact, which is potentially a fire hazard if there were a tube leakage on the heat exchanger. In addition to the above difficulties, it should be noted that currently known ambient air vaporizer systems still produce substantial quantities of cold air and associated fogging problems.

Fogging from ambient air vaporizers can be reduced, or even eliminated as is shown in U.S. Pat. No. 7,870,747, via a heat source that warms up the cooled air stream before the so heated air stream is discharged to the atmosphere. While such process can eliminate fog formation, significant heating energy is required and thus only economically feasible where a waste heat source is readily available.

Therefore, even though several systems and methods are known in the art to recover refrigeration content from LNG in air vaporizers and to reduce fogging, all or almost all of them suffer from several disadvantages. Thus, there is still a need to provide improved configurations and methods for ambient air vaporizers and cold utilization.

### SUMMARY OF THE INVENTION

The present invention is directed to systems, plants, and methods for an ambient air LNG vaporizer that includes a plurality of heat exchange conduits that receive LNG and vaporize the LNG using the heat content of the ambient air to so produce a natural gas stream and a stream of refrigerated air. In contemplated devices and methods, a housing encloses at least partially the heat exchange conduits and further comprises an ambient air intake control device and a refrigerated air outlet. A blower is fluidly coupled to the refrigerated air outlet and moves the refrigerated air from the housing to a remote refrigerated air consumer (e.g., a gas turbine combustor, air separation plant, food freezing plant, industrial air conditioning unit, and/or condenser in a power cycle). Especially preferred devices further include a control circuit that maintains the temperature of the refrigerated air at the remote refrigerated air consumer by adjusting an operational parameter of the ambient air intake control device and/or the blower.

Most preferably, the housing is configured to deliver at least 80% (and most typically all) of the refrigerated air to the blower. With respect to the ambient air intake control device it is generally preferred that such devices include a set of louvers. Thus, a preferred operational parameter of the ambient air intake control device is an opening state of the set of louvers, while a preferred operational parameter of the blower is a fan speed of the blower or compressor. It is still further generally contemplated that the control circuit also maintains the temperature of the refrigerated air at a second remote refrigerated air consumer. Where desired, the control circuit (or an additional control circuit) regulates the flow of the refrigerated air between the remote refrigerated air consumer and one or more remote refrigerated air consumers.

In further contemplated aspects of the inventive subject matter, an LNG regasification plant may also comprising a second LNG vaporizer, and a second control circuit that allows for alternating operation (heating and defrosting mode) of the LNG vaporizer and the second LNG vaporizer while maintaining flow of refrigerated air to the remote refrigerated air consumer.

While not limiting to the inventive subject matter, contemplated plants may further include a thermally insulated piping between the blower and the remote refrigerated air consumer, wherein the thermally insulated piping has a length of at least 1 km.

Consequently, and viewed from a different perspective, the inventor also contemplates a method of vaporizing LNG in an ambient air vaporizer in which LNG is vaporized in an ambient air vaporizer to produce a natural gas stream and a stream of refrigerated air, wherein the ambient air vaporizer has a housing that at least partially encloses a plurality of heat exchange conduits and further has an ambient air intake control device and a refrigerated air outlet. A blower is then used to move at least 50% (more typically at least 80%, and most typically all) of the refrigerated air from the housing to a remote refrigerated air consumer, and a control circuit is used to maintain a temperature of the refrigerated air at the remote refrigerated air consumer by adjusting an operational parameter of at least one of the ambient air intake control device and the blower.

Various objects, features, aspects and advantages of the present invention will become more apparent from the following detailed description of preferred embodiments of the invention.

### BRIEF DESCRIPTION OF THE DRAWINGS

FIG. 1 is a exemplary schematic of an LNG regasification plant with ambient air vaporizers with cold utilization according to the inventive subject matter.

FIG. 2 is an exemplary graph showing the increase in power output from lower gas turbine temperatures.

FIG. 3 is an exemplary graph showing the gas turbine performance increase from lower gas turbine temperatures.

FIG. 4 is an exemplary depiction of the ambient air vaporizer design and control system details.

### DETAILED DESCRIPTION

The inventor has discovered that various problems, and especially fogging associated with ambient air vaporizers can be avoided with conceptually simple and effective methods and configurations that also allow for use of the refrigeration content in the LNG in a safe and desirable manner.

Especially preferred systems and methods employ a low pressure ducting and blower system coupled to a housing that at least partially encloses the ambient air vaporizer, wherein the housing also includes an ambient air intake control device that is under the control of a control circuit programmed to maintain the temperature of the refrigerated air coming from the ducting by adjusting an operational parameter of the ambient air intake control device and/or the blower. It should be especially noted that by using cold air only in such systems an otherwise needed heat transfer system can be avoided, and that the LNG regasification plant and the refrigerated air consumer(s) can be positioned at a safe distance from each other. As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should also be appreciated that additional benefits arise from using air as the cold transfer medium as air allows operation of an open refrigeration loop. Unlike most known heat transfer systems in which the transfer medium must be returned to the source, air can be vented to the atmosphere at the site of the refrigerated air consumer. Indeed, it should be noted that the refrigerated air from the vaporizer air is significantly cleaner than the ambient air since most contaminants in the ambient air (e.g., particulate matter, CO₂ and CO₂ in the water condensate) are removed with the condensate at the vaporizer.

Moreover, it should be recognized that systems and methods contemplated herein can produce very cold air for the refrigerated air consumer. Indeed, the temperature is to a large degree only limited by the air flow to the ambient air vaporizer. For example, cold air can be produced at −40° F., which can be used for food freezing, or as direct feed to an air separation plant. Alternatively, or additionally, the refrigerated air can be used as a refrigerant or in an industrial air conditioning system (typically in combination with ambient air to control temperature). In most cases, production of refrigerated air (e.g., −20° F. or lower) from LNG regasification plant is particularly preferred. Among other advantages, it is noted that the refrigerated air from the ambient air vaporizer is dry as air moisture will freeze on the heat exchanger tubes. Consequently, there is no condensation in the transfer piping or ducting. Most typically, the cold air ducting will be insulated to conserve cold.

In especially preferred aspects, configurations and methods of LNG regasification will include an ambient air vaporizer that is at least partially enclosed in a housing to allow collection of substantially all (at least 80%, more typically at least 90%, most typically 100%) refrigerated air from the bottom portion of the ambient air vaporizer. Moreover, to control the temperature of the refrigerated air, it is further preferred that the vaporizer and/or housing is further coupled to an air intake control device, and especially a louver system that controls the air flow to the vaporizer. In that manner, refrigerated air at a temperature of below 32° F., preferably below 0° F., and most preferably below −20° F. can be produced and distributed via a blower/compressor for various users, without venting the cold air to the atmosphere. To maintain the temperature at a desired level, a control circuit will be configured/programmed such that air flow is increased or decreased by adjusting an operational parameter of the air intake control device (e.g., louver angles) and/or blower/compressor (e.g., fan rate). The flow distribution of the refrigerated air to the various consumers is preferably based on demand control, which may be regulated via the control circuit or separate control units. For example, where the refrigerated air consumers include a combustor of a gas turbine, an air separation plant, and industrial air conditioning, the flow control may assign first priority to the gas turbine while the remaining air is distributed for the air separation plant and the industrial air conditioning.

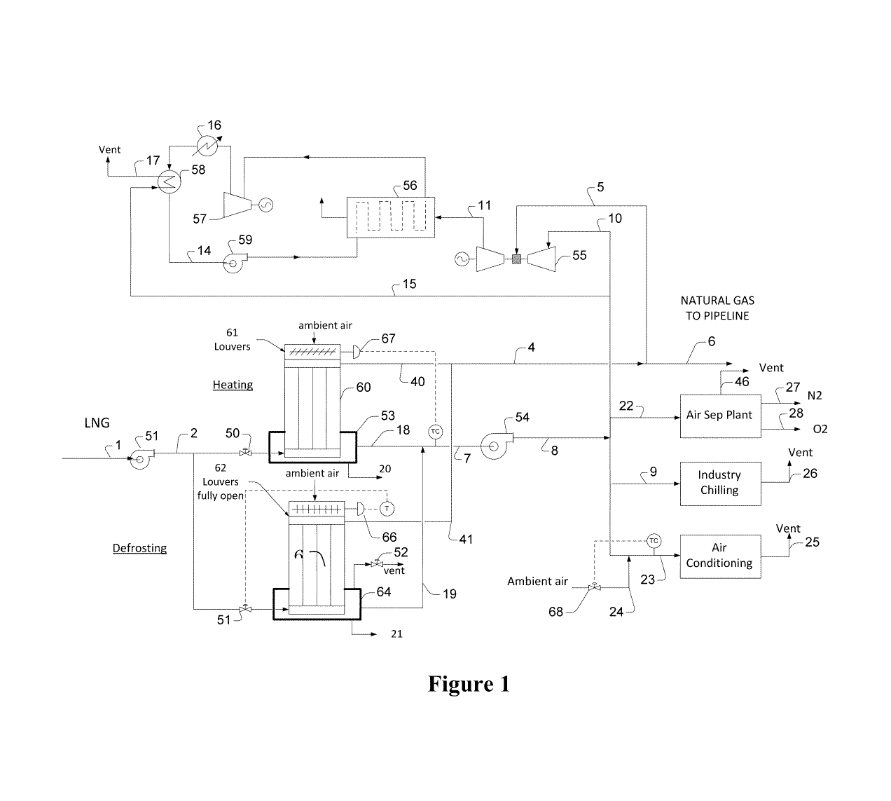

An exemplary configuration is shown in FIG. 1. Here, LNG stream 1, at a rate of about 1000 MMscfd at a pressure of about 100 psig and a temperature of about −250° F. is pumped by LNG pump 51 to about 1250 psig (or other pipeline or delivery pressure) forming stream 2. As used herein, the term “about” in conjunction with a numeral refers to a range of +/−10% of the value of that numeral, end point inclusive. The so formed cold LNG stream 2 is then heated by at least two ambient air vaporizers operating on alternating heating and defrosting cycles (first vaporizer is in heating mode while the second vaporizer is in defrosting mode). During the heating cycle, LNG is heated in vaporizer 60 with ambient air typically at about 90° F. to about 40° F., forming stream 40. The bottom chamber 53 of the vaporizer 60 is enclosed such that the refrigerated air during the heating cycle is not released to the environment, which would otherwise create fogging problems that are typical of most conventional ambient air vaporizers. During defrosting, condensate is removed via conduit 20. The defrosted water is of condensate quality and can be further processed for other water usage or used for boiler feed water makeup.

During the heating cycle, LNG inlet valve 50 is opened while the top louver 61 is partially open in order to control the air flow using controller 67 such that the exit air stream 18 is at a desired temperature, typically 32° F. or lower, while ice is built up in the lower section of the exchanger tube. During the defrosting cycle as shown in second vaporizer 63, the LNG inlet valve is closed and the louver 62 is fully opened using controller 66, which allows the full air flow to be used for defrosting. The defrosting air stream 52, which is at a higher temperature because of the higher air flow, is vented to the atmosphere. No fogging is expected because of the higher temperature. The defrosted water stream 21 (condensate) can be recovered for boiler feed water makeup or other usage in the plant. Once defrosted, second vaporizer 63 is switched over into vaporizing mode and LNG flows through valve 51 into the second vaporizer 63 and leaves second vaporizer 63 as natural gas stream 41. Refrigerated air stream 19 is then routed to the blower 54. As above, the bottom chamber 64 of the vaporizer 63 is enclosed such that the refrigerated air is not released to the environment during the heating cycle. The heated natural gas stream 4 is split into stream 5 and 6, with stream 5 used as fuel gas to the gas turbine 55, and stream 6 being transmitted to the sales gas pipeline.

Ice is formed on the surface of the fins of the vaporizer tubes, which is melted during the defrost cycle. The melted ice produces the water condensate stream 21. Cold air stream 7 is collected in the bottom basin 53, and is transported using air blower 54 forming a slightly pressurized cold air stream 8 at about 2 to 5 psig. The air is transferred to the refrigerated air consumers (warehouse cooling, office air conditioning, and other usages). Due to the low pressure operation, carbon steel ducting can be used which is inexpensive.

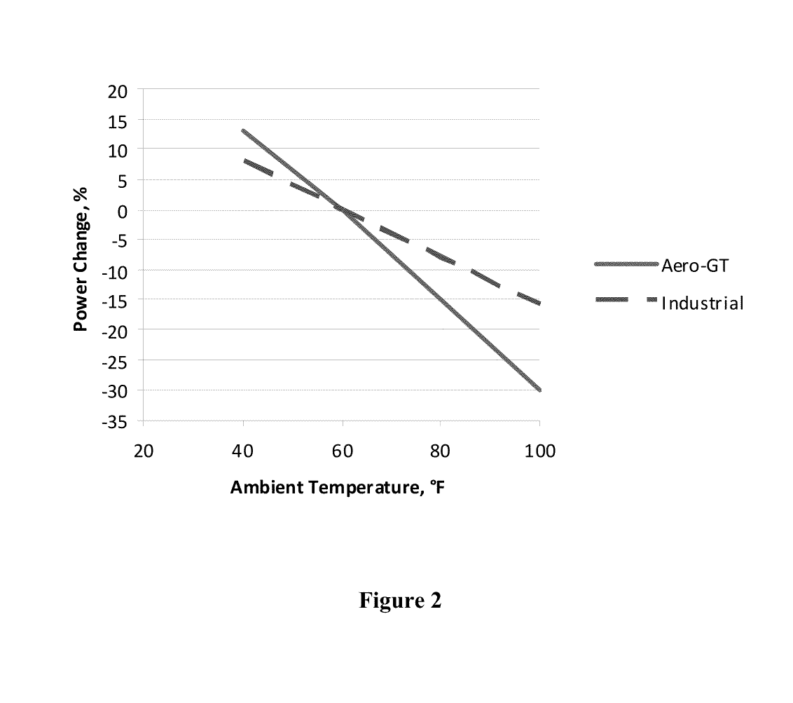

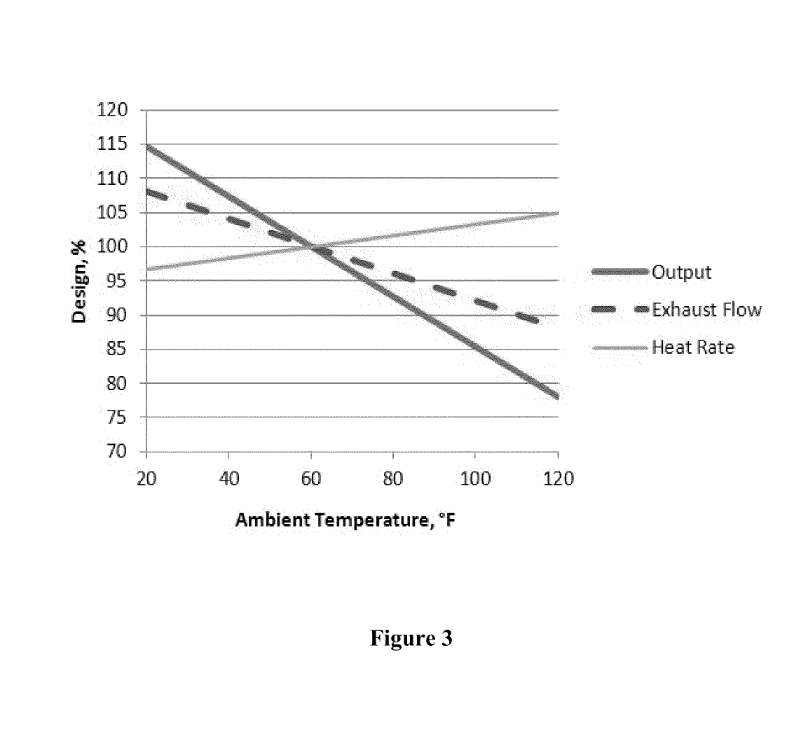

The cold air is distributed in an air ducting network to other users, such as inlet air to gas turbine stream 10 and feed gas stream 22 to air separation plant producing nitrogen stream 27 and oxygen stream 28. The impact of colder air on the power output of aero-derivative gas turbine and industrial gas turbine are exemplarily shown in FIG. 2 (depicting an increase in power output from lower gas turbine temperatures). The cold air also helps reducing degradation in heat rate due to high ambient temperature. Since gas turbine heat rate is inversely proportional to fuel efficiency, any increase in heat rate means higher fuel consumption, along with CO₂ emissions. As shown in FIG. 3 (depicting gas turbine performance increase from lower gas turbine temperatures), inlet cooling also has a positive effect on steam production and power output from the combined cycle power plants. For example, increased gas turbine mass flow entering the HRSG produces more steam which, in turn, helps increasing the steam turbine power output. The chilled air to the air separation plant can reduce the air compressor cost. The refrigeration content in the cold air can be used in providing chilling to the cold box in the cryogenic separation plant, and can save up to 50% compared to conventional design. The spent warm air can be discharged directly to the atmosphere.

Similarly for other refrigeration users, for example, industry chilling stream 9, cooling water chiller stream 15, and air conditioning unit stream 23, the refrigerated air after being used for cooling can be safely vented to the atmosphere, as in streams 25, 26, 17, and 46. The temperature of air conditioning unit 23 may further be regulated by adding ambient air to the refrigerated air stream 23 via valve 68 and associated control circuits via conduit 24.

The gas turbine 55 discharges exhaust 11 to the waste heat recovery steam generation 56 which produces steam to drive the steam turbine 57. The exhausted steam is condensed in a surface condenser 16 using cooling water, and chilled air exchanger 58 forming stream 14 which is pumped by the boiler feed water pump 59 to the steam cycle. The colder condensate temperature stream 14 lowers the condensation temperature and increases the power output from the steam turbine 57.

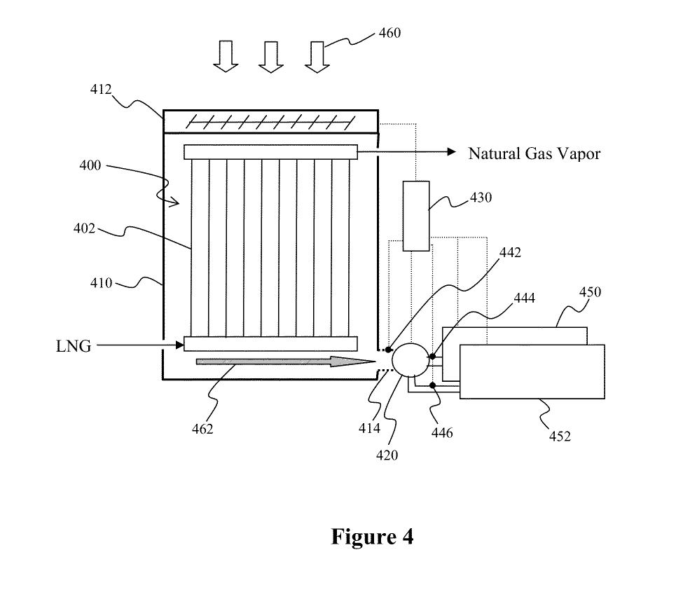

FIG. 4 depicts another exemplary ambient air vaporizer configuration in which the vaporizer 400 has a plurality of exchanger tubes 402 and is enclosed in a housing 410. The upper portion of the housing 410 comprises an air intake control device 412 (here: louver system) while the lower portion of the housing has an outlet portion 414 that is fluidly coupled to blower 420. Blower 420 and air intake control device 412 are operationally coupled to the control circuit 430 that is further operationally coupled to thermo sensors 442, 444, and 446. Control circuit 430 is also operationally coupled to refrigerated air consumers 450 and 452. Flow of ambient air 460 is regulated via the air intake control device 412 that is in turn under the control of the control circuit 430 (dotted lines). Likewise, the blower 420 is under the control of the control circuit 430 (dotted lines), and the flow of refrigerated air 462 to the refrigerated air consumers 450 and 452 is further regulated by the control circuit.

With respect to suitable ambient air vaporizers, it should be noted that all known ambient air vaporizers are suitable for use in conjunction with the inventive subject matter presented herein. However, especially preferred ambient air vaporizers are those that produce a stream of natural gas for pipeline transmission at a regasification rate of at least 50 MMscfd, more typically at least 100 MMscfd, and most typically at least 500 MMscfd. Thus, it should be noted that the LNG may be provided from a LNG transport vessel, an on-shore or off-shore LNG storage tank, and an LNG storage tank. Moreover, it should be noted that the ambient air vaporizer may be a single vaporizer, or a bank of two r more vaporizers. Indeed, it should be recognized that where multiple vaporizers use configurations and methods contemplated herein, the footprint of such vaporizer banks may be substantially reduced as (in most cases) all of the refrigerated air is removed via ducting.

It should further be appreciated that the particular configuration of the housing will in large part depend on the choice of the ambient air vaporizer(s). However, it is generally preferred that the housing at least encloses the heat exchange conduits such that incoming ambient air is passed along the fins of the heat exchange conduits to thereby heat the LNG and form refrigerated air. Moreover, it is generally preferred that the housing is configured as to allow flow control of the ambient air along the heat exchange conduits in a manner such that the temperature of the refrigerated air can be controlled via the rate of air flow passing along the heat exchange conduits. Thus, especially preferred housings will circumferentially enclose the heat exchange conduits and force the ambient air in a downward flow upon entering the housing. For example, especially preferred housings will be configured such that at least 80% (and more typically all) of the refrigerated air is delivered to the blower.

Therefore, in a particular preferred configurations, the bottom section of the vaporizer is enclosed such that cold air exiting the vaporizer is not released to the atmosphere but is piped in an air duct using an air blower to transfer to the various users. The enclosed structure avoids the fogging problems inherent in prior art ambient air vaporizers. Advantageously, the defrosting water produced from the vaporizer can be recovered for further use. Consequently, it should be recognized that in the systems and methods presented herein, the LNG cold is transferred to the cold air which is used as the heat transfer medium. Conventional heat transfer medium such as glycol water mixture is not required, consequently eliminating high capital and operating cost of the heat transfer system that includes diameter distribution pipes and circulation pump, in addition to the high cost of filling the inventory of the distribution system.

With respect to air flow it is contemplated that flow can be controlled by controlling the flow into the housing and/or controlling the flow out of the housing. For example, air flow can be restricted or increased by at least partially closing or opening one or more air intake control device. Such air intake control devices may be configured as a louver system, a plurality of conduits with associated control valves, and/or one or more blowers to build up positive air pressure at the upper portion of the vaporizer. On the other hand, air flow can also be controlled via controlled removal of the refrigerated air at or near the lower portion of the vaporizer. For example, air flow can be regulated via a blower that reduces air pressure in the housing.

Additionally, it should be noted that the housing may further include one or more passages that allow additional air to enter the housing. For example, such additional air may be derived from the environment, or may be heated air from other air sources, or refrigerated air from a recycling conduit of the vaporizer or from another vaporizer. Such additional passages will advantageously allow for further temperature control within the housing as well as of the refrigerated air leaving the housing. Of course, the flow of the additional air through passages will preferably regulated by a control circuit.

In still further contemplated aspects, preferred ambient air vaporizers will also be operationally coupled to a control circuit that is configured/programmed to maintain a desired temperature of the refrigerated air at the blower and/or remote refrigerated air consumer. In most typical cases, the control circuit will adjust an operational parameter of the ambient air intake control device (e.g., by opening or closing the louvers or other control valves) and/or the blower (e.g., fan speed or blade angle), and all known control circuits are deemed suitable for use herein (e.g., PLC controller, software controller, manual controller, etc.). In especially preferred aspects, the control circuit will be operationally coupled with one or more thermo sensors that measure the temperature at various points, and most preferably at the delivery point to the refrigerated air consumer, at the blower, and/or in upper and lower portion of the housing. Thus, contemplated control circuits will allow to adjust the temperature at any point in the generation of the refrigerated air to a desired point by (a) adjusting the air intake rate via an operational parameter of the air intake control device, (b) adjusting the removal rate of the refrigerated air from the housing via an operational parameter of the, (c) adjusting flow of additional air into the housing and/or (d) adjusting removal of refrigerated air from the housing and/or the conduit(s) to the consumer of the refrigerated air. Moreover, it should be noted that the control circuit (or a separate control circuit) may be used to prioritize air flow and/or temperature of the refrigerated air among different consumers of refrigerated air.

While not limiting to the inventive subject matter, it is generally preferred that the ambient air vaporizer and the refrigerated air consumer are separated by a distance of at least 500 m, more typically at least 1 km, and most typically at least 1.5 km. Therefore, suitable ducting that couple the vaporizer to the remote consumer will be thermally insulated with materials well known in the art.

With respect to the refrigerated air produced in the systems and methods according to the inventive subject matter, it is contemplated that the cold air can be fed directly to the gas turbine as combustion air. Colder air can increases the power output and efficiency of power generation because of the denser air. Typically, power output from gas turbine design can be increased by 1% for each 2 to 3° F. drop in temperature. Therefore, colder air such as 0° F. can increase the power generation output of a gas turbine by as much as 30 to 40%. The use of chilled air can significantly reduce the fuel gas consumption and power output, consequently, lowering the installed cost per unit of power production ($/kW). It is also contemplated that the cold air can be fed directly to an air separation plant, that reduce the feed air compressor horsepower and the refrigeration content of the cold air can be used for cooling in the cryogenic cold box that would reduce the power consumption of the air separation, by as much as 40 to 50%. Additional consumers of refrigerated air include domestic and industrial air conditioning and condensers in power cycles.

In yet another aspect of the inventive subject matter, the spent cold air after providing chilling to various users can be vented directly to the atmosphere as the air has been cleaned by condensation the contaminant from the air. No return piping is necessary that significant saves operating and capital costs. Moreover, when compared to other known configurations systems and methods, air is a safe medium as air leakage will not cause any environmental hazards, as compared to the use an intermediate fluid or direct use of LNG that are unsafe and costly.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. An ambient air liquefied natural gas (LNG) vaporizer, comprising:
a plurality of heat exchange conduits configured to receive LNG and to vaporize the LNG using heat content of ambient air, thereby producing a natural gas stream and refrigerated air;
a housing at least partially enclosing the plurality of heat exchange conduits, wherein the housing further comprises an ambient air intake control device and a refrigerated air outlet;
a blower fluidly coupled to the refrigerated air outlet and configured to move the refrigerated air from the housing to a remote refrigerated air consumer; and
a control circuit that is configured to maintain a temperature of the refrigerated air at the remote refrigerated air consumer by adjusting an operational parameter of at least one of the ambient air intake control device and the blower.

2. The LNG regasification plant of claim 1 wherein the housing is configured to deliver at least 80% of the refrigerated air to the blower.

3. The LNG regasification plant of claim 1 wherein the housing is configured to deliver all of the refrigerated air to the blower.

4. The LNG regasification plant of claim 1 wherein the ambient air intake control device comprises a set of louvers.

5. The LNG regasification plant of claim 1 wherein the operational parameter of the ambient air intake control device is an opening state of the ambient air intake control device, and wherein the operational parameter of the blower is a fan speed of the blower.

6. The LNG regasification plant of claim 1 wherein the control circuit is further configured to maintain a temperature of the refrigerated air at a second remote refrigerated air consumer.

7. The LNG regasification plant of claim 1 wherein the control circuit is further configured to regulate flow of the refrigerated air between the remote refrigerated air consumer and a second remote refrigerated air consumer.

8. The LNG regasification plant of claim 1 further comprising a second LNG vaporizer, and a second control circuit configured to allow alternating operation of the LNG vaporizer and the second LNG vaporizer while maintaining flow of refrigerated air to the remote refrigerated air consumer.

9. The LNG regasification plant of claim 1 wherein the remote refrigerated air consumer is selected from the group consisting of a gas turbine combustor, an air separation plant, a food freezing plant, an industrial air conditioning unit, and a condenser in a power cycle.

10. The LNG regasification plant of claim 1 further comprising a thermally insulated piping between the blower and the remote refrigerated air consumer, wherein the thermally insulated piping has a length of at least 1 km.

11. A method of vaporizing liquefied natural gas (LNG) in an ambient air vaporizer, comprising:
vaporizing LNG in an ambient air vaporizer to produce a natural gas stream and a stream of refrigerated air, wherein the ambient air vaporizer has a housing that at least partially encloses a plurality of heat exchange conduits and further has an ambient air intake control device and a refrigerated air outlet;
using a blower to move at least 50% of the refrigerated air from the housing to a remote refrigerated air consumer; and
using a control circuit to maintain a temperature of the refrigerated air at the remote refrigerated air consumer by adjusting an operational parameter of at least one of the ambient air intake control device and the blower.

12. The method of claim 11 wherein the blower is used to move at least 80% of the refrigerated air to the remote refrigerated air consumer.

13. The method of claim 11 wherein the refrigerated air has a temperature of equal or less than −20° F.

14. The method of claim 11 wherein the ambient air intake control device comprises a set of louvers.

15. The method of claim 11 wherein the operational parameter of the ambient air intake control device is an opening state of the ambient air intake control device, and wherein the operational parameter of the blower is a fan speed of the blower.

16. The method of claim 11 wherein the control circuit is further configured to maintain a temperature of the refrigerated air at a second remote refrigerated air consumer.

17. The method of claim 11 wherein the control circuit is further configured to regulate flow of the refrigerated air between the remote refrigerated air consumer and a second remote refrigerated air consumer.

18. The method of claim 11 further comprising a second LNG vaporizer, and a second control circuit configured to allow alternating operation of the LNG vaporizer and the second LNG vaporizer while maintaining flow of refrigerated air to the remote refrigerated air consumer.

19. The method of claim 11 wherein the remote refrigerated air consumer is selected from the group consisting of a gas turbine combustor, an air separation plant, a food freezing plant, an industrial air conditioning unit, and a condenser in a power cycle.

20. The method of claim 11 wherein the refrigerated air travels from the housing to the remote refrigerated air consumer over a distance of at least 1 km.
